(19) United States
(12) Patent Application Publication
(10) Pub. No.: US 2018/0102577 A1
(43) Pub. Date: Apr. 12, 2018

(54) METAL-AIR BATTERY FOR A VEHICLE

(71) Applicant: FORD GLOBAL TECHNOLOGIES, LLC, Dearborn, MI (US)

(72) Inventor: Jongwoo CHOI, London (GB)

(73) Assignee: FORD GLOBAL TECHNOLOGIES, LLC, Dearborn, MI (US)

(21) Appl. No.: 15/725,969

(22) Filed: Oct. 5, 2017

(30) Foreign Application Priority Data
Oct. 6, 2016 (GB) 1616987.2

(51) Int. Cl. H01M 12/06; H01M 2/02

(52) U.S. Cl. CPC H01M 12/065; H01M 2/0217; B60L 11/1879; H01M 2220/20; H01M 2/0255

(57) ABSTRACT

A metal-air battery for a vehicle may include an electrolyte and/or an electrode that is readily replaceable and/or drainable and/or fillable by an end user of the vehicle. The electrolyte may be replaced while the metal-air battery is installed on the vehicle, or while the metal-air battery is installed on a battery station, which may be separate from the vehicle. The battery may include a valve assembly configured to control the flow of electrolyte to and/or from the battery module and provided between a duct assembly and the battery module. A valve assembly may be provided on the battery module, the electrolyte module, and/or the duct assembly and configured to open upon connection of the battery module and close upon disconnection with the duct assembly. A pump may be associated with the battery module, electrolyte module and/or the duct assembly to move electrolyte therebetween.

### CROSS-REFERENCE TO RELATED APPLICATIONS

This application claims foreign priority benefits under 35 U.S.C. § 119(a)-(d) to GB Application 1616987.2 filed Oct. 6, 2016, which is hereby incorporated by reference in its entirety.

### TECHNICAL FIELD

This disclosure relates to a vehicle metal-air battery having a battery module and an electrolyte module.

### BACKGROUND

Electric vehicles generally have a more limited driving range than a gasoline or a diesel vehicle. For example, an electric vehicle powered by a lithium-ion battery may have a driving range of approximately 200 to 300 miles. However, the driving range of an electric vehicle may be extended through the use of metal-air batteries.

Metal-air batteries differ from other electro-chemical cells as they use oxygen in the air around them, rather than storing it in liquid or solid chemicals within the cell. As a result, the overall weight of the battery can be reduced, which helps to extend the range of the vehicle.

Recent studies have shown that metal-air batteries promise greater range compared to current battery technologies. One problem, however, is that metal-air batteries are not electrically rechargeable in the same manner as a lithium-ion battery, for example. Instead, a depleted metal-air battery can be replaced with a new metal-air battery, which can be a difficult task for the end user owing to the size and weight of the battery.

### SUMMARY

According to an arrangement of the present disclosure there is provided a metal-air battery for a vehicle. At least a portion of the metal-air battery, for example an electrolyte and/or an electrode, of the metal-air battery may be readily replaceable by an end user of the vehicle. The metal-air battery may be configured to allow the end user to replace, for example drain and/or refill, the electrolyte of the metal-air battery. The electrolyte may be replaced while the metal-air battery is installed on the vehicle. The electrolyte may be replaced while the metal-air battery is installed on a battery station. The battery station may be separate from the vehicle.

The metal-air battery may comprise at least one battery module. The metal-air battery may comprise at least one electrolyte module. The battery module and the electrolyte module may be separate components. The battery module and the electrolyte module may be configured to connect to each other, for example in order to connect fluidly the electrolyte module and the battery module.

The battery module may be configured to be installed on and/or removed from the vehicle by an end user of the vehicle. The electrolyte module may be configured to be installed on and/or removed from the vehicle by an end user of the vehicle. The battery module and the electrolyte module may each be a replaceable component. For example, the battery module may be configured so that the end user can remove the battery module from the vehicle and replace the battery module with another battery module. The electrolyte module may be configured so that the end user can remove the electrolyte module from the vehicle and replace the electrolyte module with another electrolyte module.

The battery module may comprise a metal electrode. The battery module may comprise a cathode. The battery module may comprise the electrolyte. The battery module may comprise a housing portion configured to house a metal anode, for example an aluminum anode, and an air cathode. The air cathode may be connected fluidly to the environment external to the battery module. The housing portion of the battery module may define an electrolyte chamber configured to connect fluidly the metal anode to the air cathode, when filled with the electrolyte.

The electrolyte module may comprise the electrolyte. The electrolyte module may comprise a housing portion that defines an electrolyte chamber. The electrolyte chamber of the battery module may be fluidly connectable to the electrolyte chamber of the electrolyte module. The metal-air battery may be configured to allow the end user to readily replace the metal anode, the air cathode and/or the electrolyte of the metal-air battery. The electrolyte module may be configured to allow the end user to readily replace the electrolyte of the electrolyte module.

The metal-air battery may comprise at least one duct assembly configured to connect fluidly the battery module and the electrolyte module. For example, the duct assembly may connect fluidly the electrolyte chamber of the battery module to the electrolyte chamber of the electrolyte module. The duct assembly may be configured to permit the flow of electrolyte between the battery module and the electrolyte module. The duct assembly may comprise at least one pump configured to pump electrolyte between the battery module and the electrolyte module. The duct assembly may be configured to simultaneously pump electrolyte from the electrolyte module to the battery module, and from the battery module to the electrolyte module, for example using one or more portions of ducting. The duct assembly may comprise a first coupling configured to connect the battery module to the duct assembly. The duct assembly may comprise a second coupling configured to connect the electrolyte module to the duct assembly.

The metal-air battery may comprise a valve assembly, for example a first valve assembly, configured to control the flow of electrolyte to and/or from the battery module. The first valve assembly may be provided between the duct assembly and the battery module. The first valve assembly may be provided on the battery module. The first valve assembly may be provided on the duct assembly, for example on the first coupling of the duct assembly. The first valve assembly may be configured to open upon connection of the battery module with the duct assembly, for example as a result of the battery module being inserted into the first coupling of the duct assembly. The first valve assembly may be configured to open by virtue of an interaction between the battery module and the duct assembly. The first valve assembly may be configured to close upon disconnection of the battery module from the duct assembly, for example as a result of the battery module being removed from the first coupling of the duct assembly.

The metal-air battery may comprise a valve assembly, for example a second valve assembly, configured to control the flow of electrolyte to and/or from the electrolyte module. The second valve assembly may be provided between the duct assembly and the electrolyte module. The second valve assembly may be provided in the electrolyte module. The second valve assembly may be provided in the duct assembly, for example on the second coupling of the duct assembly. The second valve assembly may be configured to open upon connection of the electrolyte module with the duct assembly, for example as a result of the electrolyte module being inserted into the second coupling of the duct assembly. The second valve assembly may be configured to open by virtue of an interaction between the electrolyte module and the duct assembly. The second valve assembly may be configured to close upon disconnection of the electrolyte module from the duct assembly, for example as a result of the electrolyte module being removed from the second coupling of the duct assembly.

The battery module and the electrolyte module may be configured to connect to allow the transfer of electrolyte directly between the electrolyte chamber of the battery module and the electrolyte chamber of the electrolyte module, for example without the use of the duct assembly. The provision of the duct assembly may be advantageous as is allows the battery module and the electrolyte module to be spaced apart, when installed on the vehicle.

There is also provided a vehicle comprising at least a portion of the above described metal-air battery. For example, the vehicle may comprise the battery module, the electrolyte module and/or the duct assembly.

The battery module may be fixed to the vehicle and the electrolyte module may be readily replaceable. The configuration of the battery module may be such that it is not intended that the battery module be replaced during the routine operation of the vehicle, whereas the electrolyte module may be configured to be easily removed from and/or installed on the vehicle. The metal-air battery may comprise a single fixed battery module and a plurality of replaceable electrolyte modules.

The electrolyte module may be fixed to the vehicle and the battery module may be readily replaceable. The configuration of the electrolyte module may be such that it is not intended that the electrolyte module be replaced during the routine operation of the vehicle, whereas the battery module may be configured to be easily removed from and/or installed on the vehicle. The metal-air battery may comprise a single fixed electrolyte module and a plurality of replaceable battery modules. The electrolyte module may be a fuel tank of the vehicle.

The electrolyte module may provide means for the vehicle to carry a replacement supply of electrolyte, so that the electrolyte of the battery module may be readily exchanged with the electrolyte of the electrolyte module, in order to extend the driving range of the vehicle.

According to another arrangement of the present disclosure there is provided a metal-air battery station for use by an end user of a vehicle. The metal-air battery station may be configured to replace at least a portion of the metal-air battery, for example an electrolyte of the metal-air battery. The metal-air battery station may be configured to replace depleted electrolyte in an electrolyte module of the metal-air battery with fresh electrolyte. The metal-air battery station may be configured to replace a depleted metal electrode of a battery module of the metal-air battery with a fresh metal electrode.

The metal-air battery station may be configured to dispense at least one of the battery module of the metal-air battery and the electrolyte module of the metal-air battery, for use by the end user of the vehicle. The metal-air battery station may be configured to receive at least one of a depleted battery module of the metal-air battery and a depleted electrolyte module of the metal-air battery.

The metal-air battery station may be connectable to an electrolyte supply, for example an external electrolyte supply. The metal-air battery station may be configured to connect fluidly the electrolyte supply to a metal-air battery installed on a vehicle. The metal-air battery station may be configured to drain depleted electrolyte from the metal-air battery of the vehicle, and/or refill the electrolyte of the metal-air battery of the vehicle, for example without removing the metal-air battery from the vehicle.

The metal-air battery station may be a vending machine configured to dispense at least one of the battery module, the electrolyte module and fresh electrolyte. For example, the metal-air battery station may be configured to accept payment for at least one of the battery module, the electrolyte module and the fresh electrolyte.

According to another arrangement of the present disclosure there is provided a metal-air battery system. The system may comprise a metal-air battery for a vehicle. The system may comprise a metal-air battery station configured to replace at least a portion of the metal-air battery.

According to another arrangement of the present disclosure there is provided a method of replenishing a metal-air battery for a vehicle. The method may comprise replacing an electrolyte of the metal-air battery, wherein the replacement of the electrolyte is readily achievable by an end user of the vehicle. The method may comprise replacing an electrode of the metal-air battery, wherein the replacement of the electrode is readily achievable by an end user of the vehicle.

The replacement of the electrolyte may comprise at least one of: draining a depleted electrolyte from the metal-air battery; connecting fluidly a supply of new electrolyte to the metal-air-battery; and filling the metal-air battery with the fresh electrolyte.

The method may comprise at least one of: draining the depleted electrolyte from a battery module into an electrolyte module; and filling the fresh electrolyte from the electrolyte module into the battery module. At least one of the draining of the electrolyte and the filling of the electrolyte may be conducted while the metal-air battery is installed in the vehicle.

The method may comprise at least one of: removing a depleted battery module from the vehicle; installing a fresh battery module on the vehicle; removing an electrolyte module filled with depleted electrolyte from the vehicle; and installing an electrolyte module filled with fresh electrolyte on the vehicle. The depleted battery module and/or the fresh battery module may be drained of electrolyte.

The method may comprise at least one of: obtaining at least one of the battery module and the electrolyte module from a metal-air battery station; and returning at least one of the battery module and the electrolyte module to the metal-air battery station or another metal-air battery station.

At least one of the draining of the electrolyte and the filling of the electrolyte may be conducted while the metal-air battery is installed in a metal-air battery station.

To avoid unnecessary duplication of effort and repetition of text in the specification, certain features are described in relation to only one or several aspects or arrangements of the disclosure. However, it is to be understood that, where it is technically possible, features described in relation to any aspect or arrangement of the disclosure may also be used with any other aspect or arrangement of the disclosure.

For a better understanding of the present disclosure, and to show more clearly how it may be carried into effect, reference will now be made, by way of example, to the accompanying drawings, in which:

### BRIEF DESCRIPTION OF THE DRAWINGS

FIG. 1 shows a battery module of a metal-air battery according to a representative embodiment;

FIG. 2 shows an electrolyte module of a metal-air battery according to a representative embodiment;

FIGS. 3A to 3C show various arrangements of a metal-air battery according to representative embodiments;

FIG. 4 shows a metal-air battery station according to a representative embodiment; and

FIGS. 5A and 5B show a metal-air battery system according to a representative embodiment.

### DETAILED DESCRIPTION

As required, detailed embodiments are disclosed herein; however, it is to be understood that the disclosed embodiments are merely representative and may be embodied in various and alternative forms. The figures are not necessarily to scale; some features may be exaggerated or minimized to show details of particular components. Therefore, specific structural and functional details disclosed are not to be interpreted as limiting, but merely as a representative basis for teaching one skilled in the art to variously employ the embodiments and variations whether or not explicitly described or illustrated.

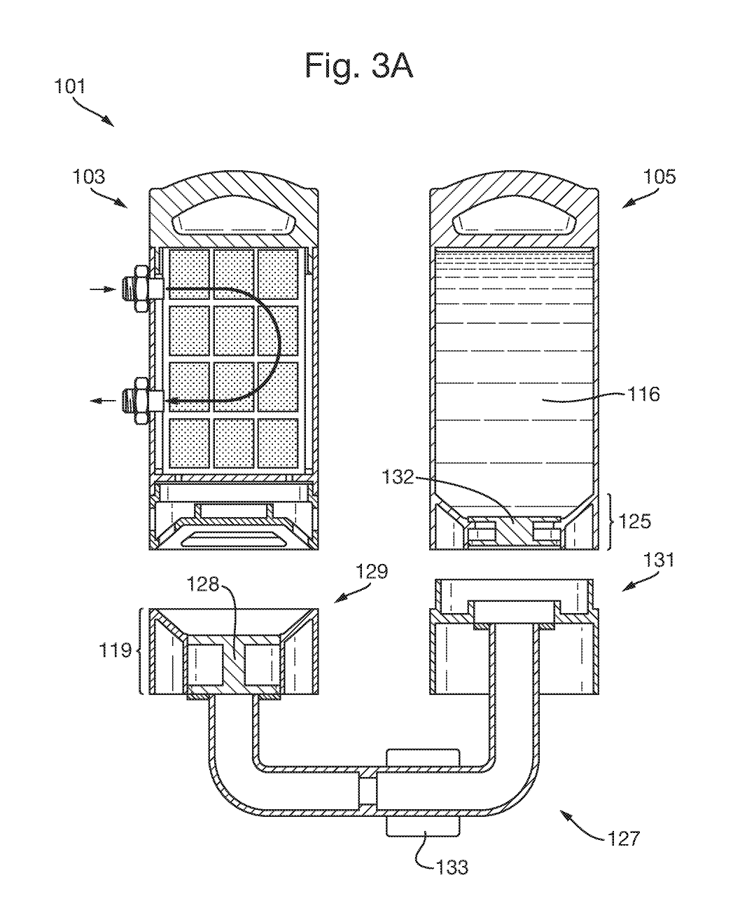

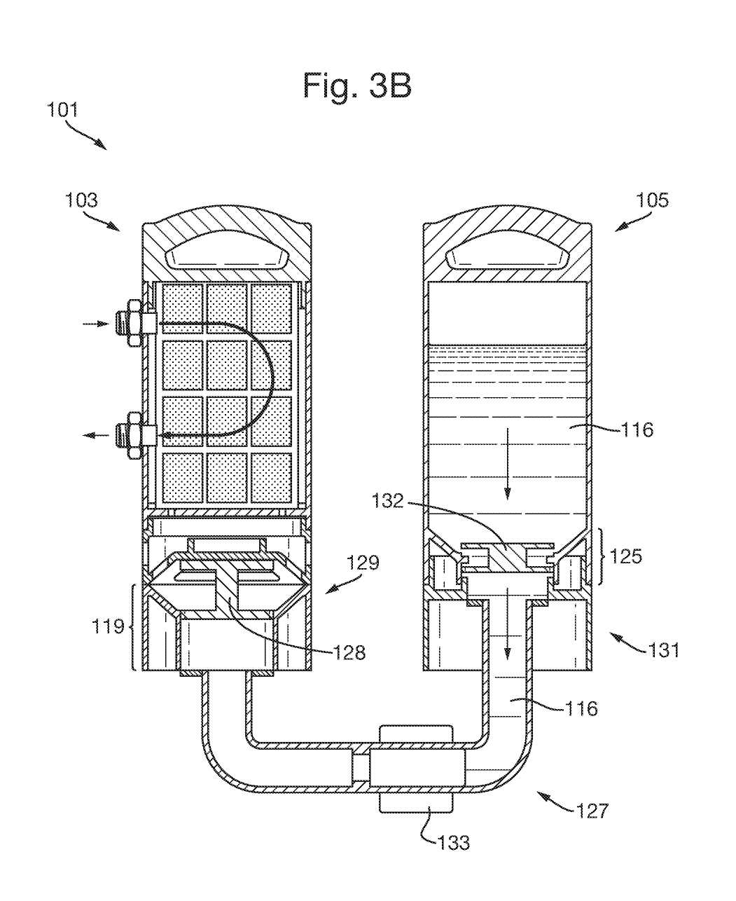

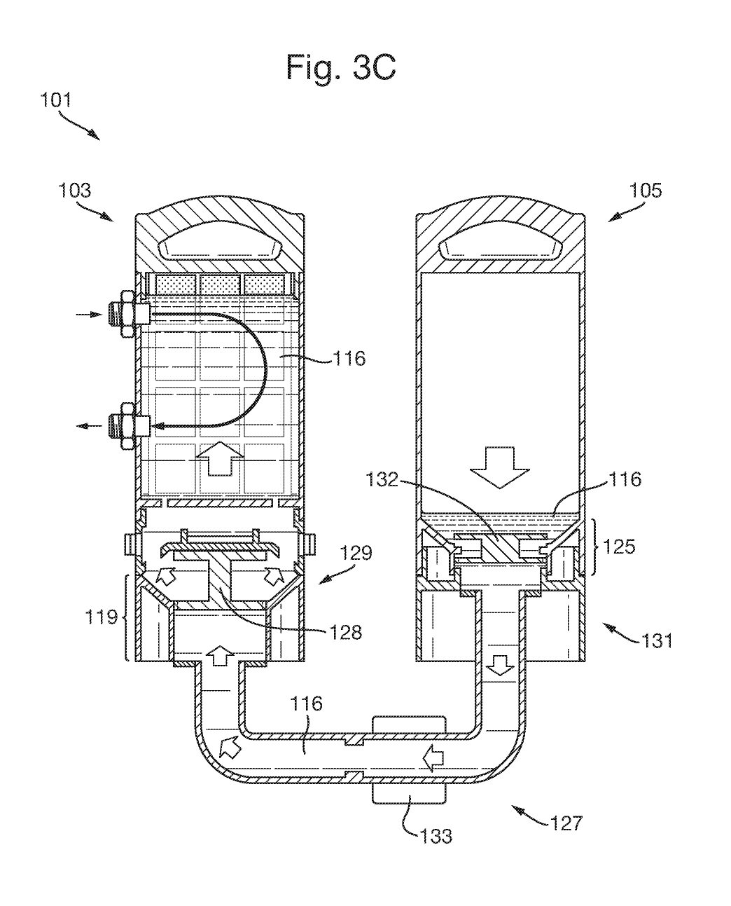

The present disclosure provides a metal-air battery 101 (FIGS. 3A-3C) for a vehicle. The vehicle may be any type of vehicle which uses a battery to power one or more systems of the vehicle. In the below description, the metal-air battery 101 is a battery that is used to power a motor or electric machine of the vehicle, sometimes referred to as a motor-generator or traction motor. However, the metal-air battery 101 may be used to power any appropriate device.

Electric vehicles generally have a more limited driving range than gasoline or diesel powered vehicle, which may be a result of an electrode and/or an electrolyte of the battery becoming depleted. In the context of the present disclosure, the terms “depleted electrolyte” and “depleted electrode” are used to describe an electrolyte and an electrode respectively whose functional efficiency has dropped below a predetermined level. Once the electrolyte and/or the electrode has become depleted, the efficiency of the metal-air battery 101 may be such that at least one of the depleted electrode and the depleted electrolyte requires replacement. One problem associated with metal-air batteries, however, is that the electrolyte depletes at a faster rate than a metal anode of the metal-air battery 101. As a result, the electrolyte may need to be replaced at more frequent intervals than the metal anode. The present disclosure provides an improved metal-air battery 101 that can extend the driving range of the vehicle by allowing the electrolyte of the metal-air battery 101 to be readily replaced by an end user of the vehicle. In this manner, the entire metal-air battery 101 need not be replaced when the functional efficiency of the battery drops below the predetermined level.

In the context of the present disclosure, the term “end user” is understood to mean the consumer, for example a person who purchases goods for personal use, or in other words, a person who actually uses a particular product. For example, the end user of the vehicle may typically be the driver of the vehicle, and/or one or more passengers of the vehicle. It is understood, therefore, that the metal-air battery 101 according to the present disclosure is configured so that the driver and/or a passenger of the vehicle can replace the electrolyte of the metal-air battery 101 in a similar manner to refilling a fuel tank of a conventional gasoline-fueled or diesel-fueled vehicle.

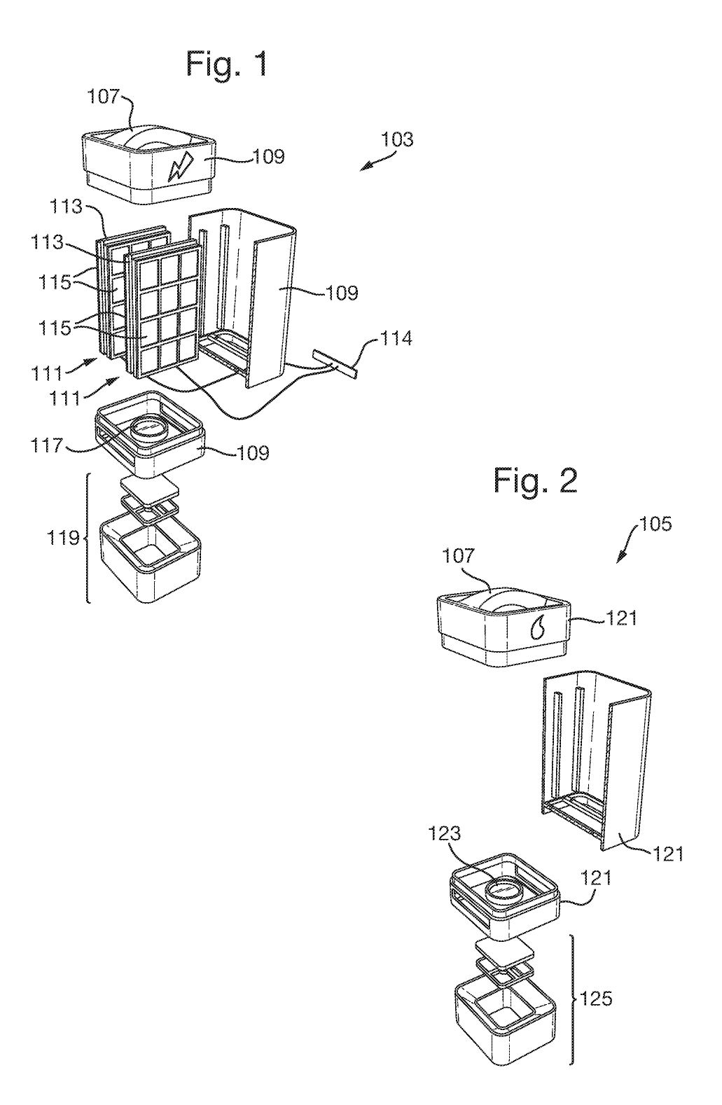

FIGS. 1-3 show a battery module 103 and an electrolyte module 105 of the metal-air battery 101 respectively. The battery module 103 is configured to be installed on and/or removed from the vehicle by the end user. For example, the battery module 103 comprises a handle 107 that can be used to carry the battery module 103. The battery module 103 may be appropriately sized so that it can be carried and lifted by the end user of the vehicle. In one arrangement, the battery module 103 may have a mass in the range of 0.5 to 5 kilograms, for example when the battery module 103 is or is not filled with electrolyte.

The battery module 103 comprises a casing 109 that is configured to house the components of the metal-air battery 101. In the arrangement shown in FIG. 1, the casing 109 is configured to house one or more electrode assemblies 111 formed from at least one metal anode 113 and at least one air cathode 115. The casing is provided with an electrical connector 114, which is configured to connect electrically the battery module 103 with one or more other battery modules 103 and/or one or more vehicular systems.

The casing 109 is configured to seal an electrolyte 116 within the battery module 103, such that the electrolyte 116 fluidly connects the metal anode 113 to the air cathode 115. The electrolyte 116 may be water, or any other appropriate type of electrolyte. The casing 109 comprises a sealable opening 117 configured to allow the electrolyte 116 to flow between the interior and exterior of the casing 109 of the battery module 103. The battery module 103 comprises a valve assembly 119 configured to control the flow of electrolyte 116 across the opening 117 in the casing 109.

The casing 109 is provided with one or more ports configured to allow gas, for example air or oxygen, to flow between the exterior of the battery module 103 and the air cathode 115. In another arrangement, the air cathode 115 may form at least a portion of the exterior surface of the casing 109, so that the air cathode 115 is in direct contact with the environment external to the battery module 103.

In a similar manner to the battery module 103, the electrolyte module 105 is configured to be installed on and/or removed from the vehicle by the end user. In one arrangement, the electrolyte module 105 is configured to store the electrolyte 116, for example water. However, the electrolyte module 105 may be configured to store any appropriate type of electrolyte 116. The electrolyte module 105 comprises a casing 121, an opening 123 and a valve assembly 125 similar to those of the battery casing 109, so that the electrolyte 116 can be stored in the casing 121 and transferred across the opening 123 by way of operation of the valve assembly 125.

In the arrangement shown in FIGS. 1 and 2, the battery module 103 and the electrolyte module 105 are similarly shaped and sized. For example, at least one of the casing 109 and the valve assembly 119 of the battery module 103 may be of the same respective configuration as the casing 121 and the valve assembly 125 of the electrolyte module 105. However, in one or more alternative arrangements, the battery module 103 and electrolyte module 105 may be independently configured.

In one arrangement, at least one of the battery module 103 and the electrolyte module 105 is a replaceable component. For example, where the metal-air battery 101 is configured for use with the vehicle, either of the battery module 103 and the electrolyte module 105 may be uninstalled from the vehicle, and replaced by another battery module 103 or another electrolyte module 105. In this manner, it is possible to replace a depleted battery module 103 with a fresh battery module 103, and/or replace a depleted electrolyte module 105 with a fresh electrolyte module 105. In one arrangement, the battery module 103 may be a fixed battery module 103 that is not readily removable from the vehicle by the end user, and the electrolyte module 105 may be a replaceable module. Such an arrangement allows for the battery module 103 to be replaced during maintenance of the vehicle by a technician, and the electrolyte module 105 to be replaced during the day-to-day operation of the vehicle by the end user.

FIGS. 3A to 3C show various arrangements of the metal-air battery 101, which describe a possible operational mode of the metal-air battery 101. The metal-air battery 101 of FIGS. 3A to 3C includes a battery module 103, an electrolyte module 105 and a duct assembly 127. The duct assembly 127 is configured to fluidly connect the battery module 103 and the electrolyte module 105. Either end of the duct assembly 127 may comprise a connector configured to receive the battery module 103 or the electrolyte module 105. In the arrangement shown in FIGS. 3A to 3C, one end of the duct assembly 127 comprises a battery module connector 129 configured to receive the battery module 103, and the other end of the duct assembly 127 comprises an electrolyte module connector 131 configured to receive the electrolyte module 105. The connectors 129, 131 of the duct assembly 127 may each be configured to releasably secure the battery module 103 and the electrolyte module 105 to the duct assembly 127, for example by virtue of one or more fasteners and/or releasable snap fixings to facilitate installation and removal of at least one of the battery module 103 and the electrolyte module 105 by an end user without using tools. In one arrangement, the metal-air battery 101 may comprise a controller configured to control the connection between the duct assembly 127 and either or both of the battery module 103 and the electrolyte module 105. For example, the controller may be configured to control the release of the either or both of the battery module 103 and the electrolyte module 105 depending on the operational state, e.g. the functional efficiency, of the metal-air battery 101.

In the arrangement shown in FIGS. 3A to 3C, the battery module 103 does not comprise the valve assembly 119, as shown in the arrangement of FIG. 1. Instead, the battery module connector 129 of the duct assembly 127 comprises the valve assembly 119. It is understood, however, that the valve assembly 119 may be provided on the battery module 103 in addition to or alternatively from arrangements shown in FIGS. 3A to 3C. In contrast, the electrolyte module connector 131 does not comprise the valve assembly 125, the valve assembly 125 being provided on the electrolyte module 105 in this case.

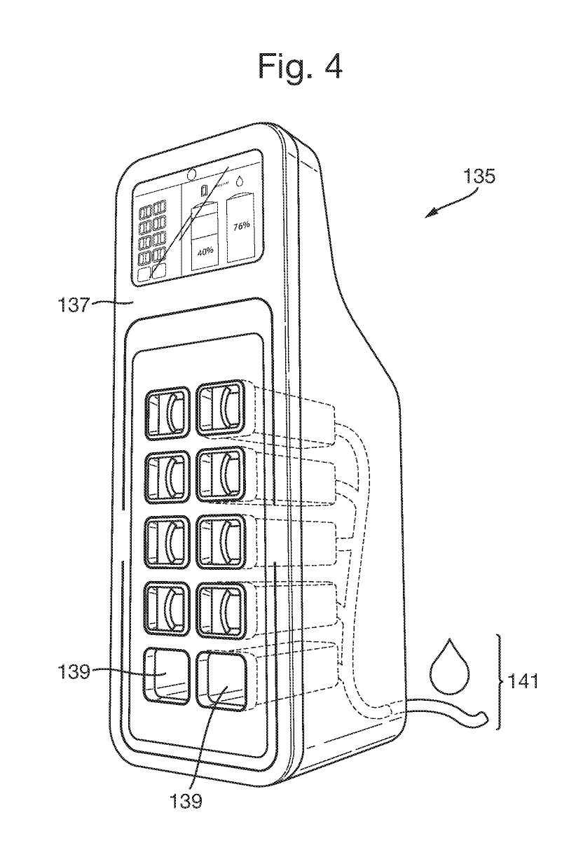

A method of refilling the electrolyte of the battery module 103 will now be described with reference to FIGS. 3A to 3C and FIG. 4. The method may comprise the steps of draining a used electrolyte from the battery module 103, connecting fluidly a supply of new electrolyte 116 to the battery module 103, and filling the battery module 103 with the supply of new electrolyte 116.

With reference to FIGS. 3A to 3C, FIG. 3A shows a drained battery module 103 and a full electrolyte module 105, each of the modules 103, 105 being disconnected from the duct assembly 127. FIG. 3B shows the step of establishing a fluid connection between the battery module 103 and the electrolyte module 105 by virtue of the duct assembly 127. In FIG. 3B, the battery module 103 has been inserted into the battery module connector 129 of the duct assembly 127, which causes a first valve 128 to move from a closed position and an open position. In a similar manner, the electrolyte module 105 has been inserted into the electrolyte module connector 131 of the duct assembly 127, which causes a second valve 132 to move between a closed position and an open position. As a result of inserting both of the battery module 103 and the electrolyte module 105 into the respective connectors 129, 131 of the duct assembly 127, a fluidic connection is established between the battery module 103 and the electrolyte module 105. FIG. 3B shows the electrolyte 116 flowing from the electrolyte module 105 into the duct assembly 127.

FIG. 3C shows the transfer of the electrolyte 116 from the electrolyte module 105 into the battery module 103. In one arrangement, the duct assembly 127 may comprise a pump 133 configured to flow electrolyte 116 between the electrolyte module 105 and the battery module 103. Alternatively or additionally, the metal-air battery 101 may be configured to pressurize at least one of the battery module 103 and that the electrolyte module 105 to cause the electrolyte 116 to flow between the battery module 103 and the electrolyte module 105. In an alternative arrangement, the electrolyte 116 may simply be gravity fed between the electrolyte module 105 and the battery module 103.

The arrangements shown in FIGS. 3A to 3C, show the filling of electrolyte 116 into a pre-drained battery module 103. However, the method may comprise a step of draining a battery module 103 that is full of depleted electrolyte 116 into an empty electrolyte module 105. Once the battery module 103 has been drained of depleted electrolyte 116, and the electrolyte module 105 has been filled with the depleted electrolyte 116, the electrolyte module 105 may be removed from the electrolyte module connector 131 of the duct assembly 127 assembly, and replaced with another electrolyte module 105 filled with fresh electrolyte 116.

In another arrangement, the battery module 103 may be filled with depleted electrolyte 116 and the electrolyte module 105 may be filled with fresh electrolyte 166, when inserted into respective connectors 139, 131 of the duct assembly 127 assembly. In such an arrangement, the metal-air battery 101 may be configured to simultaneously transfer the depleted electrolyte 116 into the electrolyte module 105, and the fresh electrolyte 116 into the battery module 103. Such a transfer may be carried out using a single duct assembly 127 which allows for the transfer of depleted electrolyte 116 and fresh electrolyte 116 at the same time. Additionally or alternatively, the metal-air battery 101 may comprise another duct assembly 127 and/or one or more further valve assemblies 119, 125 configured to effect the above described simultaneous transfer of depleted electrolyte 116 and fresh electrolyte 116.

FIG. 4 shows a battery station 135 for use with the above mentioned metal-air battery 101. The battery station 135 comprises a housing 137 having one or more openings 139 configured to receive the battery module 103 and/or electrolyte module 105. In the arrangement shown in FIG. 4, each of the openings 139 has a similar configuration since the battery module 103 and the electrolyte module 105 are of similar shape and size. However, in another arrangement, the openings 139 may have any appropriate configuration. For example, the housing 137 may comprise a battery module opening configured to receive only the battery module 103, and an electrolyte module opening configured to receive only the electrolyte module 105. In this manner, the electrolyte module 105 may not be placed in an opening for the battery module 103, and the battery module 103 may not be placed in an opening for the electrolyte module 105.

The battery station 135 may be a refilling station that is configured to drain depleted electrolyte 116 from the electrolyte module 105 and refill the electrolyte module 105 with fresh electrolyte 116. For example, a driver of the vehicle may remove an electrolyte module 105 filled with depleted electrolyte 116 from the vehicle, deposit the electrolyte module 105 filled with depleted electrolyte into the battery station 135, and the battery station 135 may drain and refill the electrolyte module 105, so that the driver may reinstall the electrolyte module 105 on the vehicle. Additionally or alternatively, the battery station 135 may be configured to receive the electrolyte module 105 filled with depleted electrolyte, and dispense another electrolyte module 105 filled with fresh electrolyte.

In one arrangement, the battery station 135 may be connected to an external electrolyte reservoir 141. For example, the battery station 135 may be configured to drain depleted electrolyte 116 from the electrolyte module 105 and refill the electrolyte module 105 with fresh electrolyte 116 from the electrolyte reservoir 141. Additionally or alternatively, the battery station 135 may comprise an internal supply of electrolyte 116, which may be drained and/or refilled periodically during maintenance of the battery station 135.

In one arrangement, the battery station 135 may be configured to connect the electrolyte supply 141 to the metal-air battery 101 of the vehicle. For example, the battery station 135 may comprise a fluidic coupling, such as a hose, that is connectable directly to the battery module 103 and/or the electrolyte module 105 installed on the vehicle. In this manner, the electrolyte 116 can be drained and/or filled as required, without the need for removing either of the battery module 103 or the electrolyte module 105 from the vehicle. In one arrangement, the battery station 135 may be connectable to the battery module connector 129 and/or the electrolyte module connector 131 of the duct assembly 127, so that the battery module 103 can be drained and/or filled as required.

The battery station 135 may be configured to receive at least one depleted battery module 103. For example, where the battery module 103 has been drained and refilled a plurality of times with electrolyte 116, the metal anode of the battery module 103 may require replacement. In one arrangement, the present disclosure allows for the end user to remove a depleted battery module 103, for example which has been drained of electrolyte 116, and then deposit the depleted battery module 103 in the battery station 135. The end user may then take a fresh battery module 103 from the battery station 135 and reinstall it in the vehicle.

In one arrangement, the battery station 135 may be configured to remove a depleted metal anode from the battery module 103, and replace the depleted metal anode with a fresh metal anode. In this manner, the battery station 135 may be configured to recondition the battery module 103 in addition to or alternatively from the refilling of the electrolyte module 105.

In one arrangement, the battery station 135 may be configured to vend at least one of the electrolyte module 105 and the battery module 103. In this manner, the battery station 135 may serve as a refueling station for the vehicle.

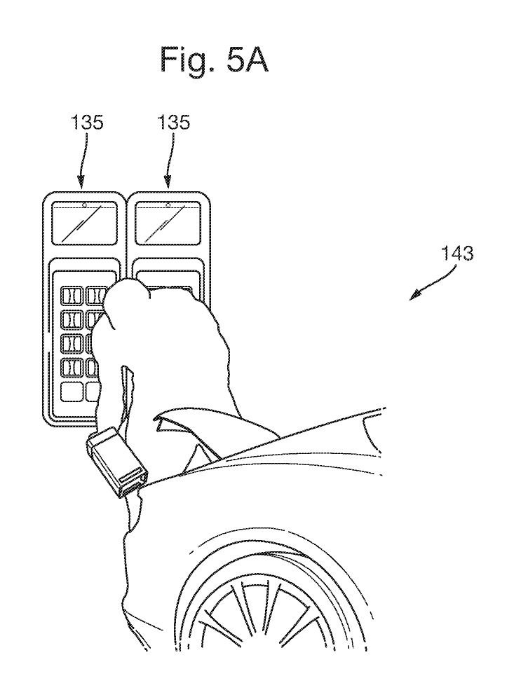

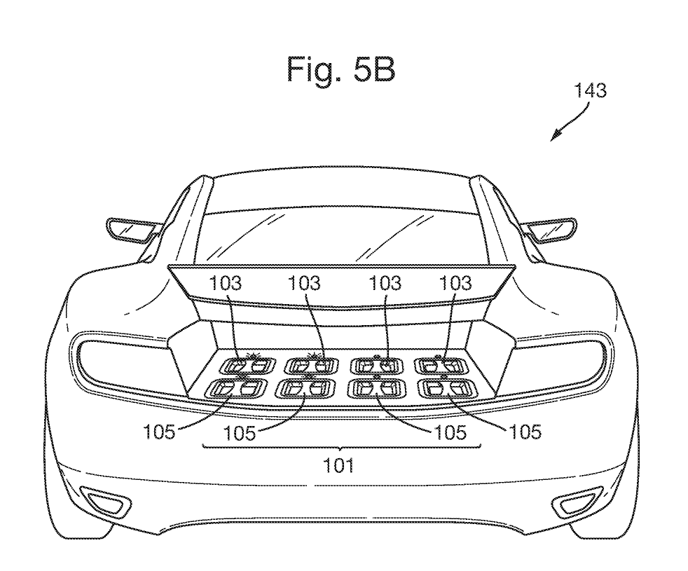

FIGS. 5A and 5B show a metal-air battery system 143 comprising at least one metal-air battery 101, for example the metal-air battery 101 of the vehicle, and a plurality of the battery stations 135. FIG. 5A shows an arrangement where the battery modules 103 and electrolyte modules 105 are arranged in a trunk of the vehicle, and depicts the end user removing a depleted electrolyte module 105 from the vehicle, and replacing the depleted electrolyte module 105 with a fresh electrolyte module 105, which may be obtained from the battery station 135.

The battery station 135 may be placed in any appropriate location where it is convenient for the end user to replace the electrolyte module 105 and/or the battery module 103 of the vehicle. For example, the battery station 135 may be configured to be installed in a parking lot, a place of work and/or at the home of the end user.

It will be appreciated by those skilled in the art that although the claimed subject matter has been described by way of example with reference to one or more examples, it is not limited to the disclosed examples and that alternative examples could be constructed without departing from the scope of the disclosure as defined by the appended claims.

While representative embodiments are described above, it is not intended that these embodiments describe all possible forms of the claimed subject matter. The words used in the specification are words of description rather than limitation, and it is understood that various changes may be made without departing from the spirit and scope of the disclosure and claimed subject matter. Additionally, the features of various implementing embodiments may be combined to form further embodiments that are not explicitly illustrated or described.

What is claimed is:

1. A vehicle metal-air battery, comprising:
a battery module comprising a first casing and an electrode assembly having a metal anode and an air cathode disposed within the first casing;
an electrolyte module comprising a second casing configured to contain an electrolyte;
a valve selectively fluidly connecting the battery module to the electrolyte module via a duct assembly; and
an electrical connector configured to connect the battery module with another battery module or a vehicle system.

2. The vehicle metal-air battery of claim 1 further comprising a handle connected to at least one of the first casing and the second casing.

3. The vehicle metal-air battery of claim 1 further comprising a pump configured to pump the electrolyte between the battery module and the electrolyte module.

4. The vehicle metal-air battery of claim 3 wherein the pump is disposed within the duct assembly.

5. The vehicle metal-air battery of claim 1 wherein the electrolyte comprises water.

6. The vehicle metal-air battery of claim 1 wherein at least one of the battery module and the electrolyte module is configured to be installed on and/or removed from a vehicle by an end user of the vehicle without using tools.

7. The vehicle metal-air battery of claim 1 wherein the duct assembly is configured for permanent installation on a vehicle.

8. The vehicle metal-air battery of claim 1 wherein the duct assembly comprises:
a battery module connector configured to receive the battery module;
an electrolyte module connector configured to receive the electrolyte module; and
a duct fluidly connected between the battery module connector and the electrolyte module connector.

9. The vehicle metal-air battery of claim 8 wherein at least one of the battery module connector and the electrolyte module connector is configured to receive a signal from a controller to selectively release either or both of the battery module and the electrolyte module from the duct assembly.

10. The vehicle metal-air battery of claim 1 wherein the valve is configured to open upon connection of the battery module to the duct assembly.

11. The vehicle metal-air battery of claim 1 wherein the valve is configured to open upon connection of the electrolyte module to the duct assembly.

12. The vehicle metal-air battery of claim 1 wherein the valve is connected to the battery module and is configured to close upon disconnection of the battery module from the duct assembly.

13. The vehicle metal-air battery of claim 1 wherein the valve is connected to the battery module, the metal-air battery further comprising a second valve connected to the electrolyte module, wherein the valve and the second valve are configured to open upon connection of the battery module and electrolyte module, respectively, to the duct assembly, and to close upon disconnection of the battery module and the electrolyte module, respectively, from the duct assembly.

14. A metal-air battery system comprising:
a vehicle metal-air battery having a battery module containing a cathode and an anode, and an electrolyte module configured to selectively provide an electrolyte to the battery module, at least one of the battery and electrolyte modules being removable; and
a metal-air battery station having an opening for receiving the at least one removable module and to replace the electrolyte contained therein.

15. The metal-air battery system of claim 14 wherein the at least one removable module comprises a handle configured for removing and carrying the module.

16. The metal-air battery system of claim 14 further comprising a duct assembly installed in a vehicle, the duct assembly comprising:
a battery module connector configured to receive the battery module;
an electrolyte module connector configured to receive the electrolyte module; and
a duct fluidly connected between the battery module connector and the electrolyte module connector; and
wherein the vehicle metal-air battery further comprises a first valve associated with the battery module that operates in response to installing or removing the battery module, and a second valve associated with the electrolyte module that operates in response to installing or removing the electrolyte module.

17. The metal-air battery system of claim 14 wherein the metal-air battery station is configured to replace used electrolyte from an electrolyte module placed in the opening with fresh electrolyte.

18. A metal-air battery system for a vehicle, comprising:
a battery module having a casing with a metal cathode and an air anode;
an electrolyte module having a casing configured to contain an electrolyte; and
a valve configured to contain the electrolyte within at least one of the battery module and the electrolyte module when removed from the vehicle and to fluidly couple the battery module and the electrolyte module when installed in the vehicle.

19. The metal-air battery system of claim 18 further comprising a duct assembly mounted to the vehicle, the duct assembly comprising:
a battery module connector configured to receive the battery module;
an electrolyte module connector configured to receive the electrolyte module;
a duct fluidly connecting the battery module connector and the electrolyte module connector; and
a pump configured to pump the electrolyte through the duct.

20. The metal-air battery system of claim 19 further comprising a handle connected to at least one of the battery module and the electrolyte module configured for removing and carrying the at least one module.
